(19) United States
(12) Patent Application Publication
(10) Pub. No.: US 2011/0317642 A1
(43) Pub. Date: Dec. 29, 2011

(54) SYSTEM AND PROCESS FOR TRANSMISSION SEQUENCE NUMBER MANAGEMENT IN AN INTRA-NODE B UNSYNCHRONIZED SERVING CELL CHANGE

(75) Inventors: Srinivasa R. Eravelli, San Diego, CA (US); Hailiang Cai, San Diego, CA (US); William L. Atkinson, Ontario (CA); Sumanth Govindappa, San Diego, CA (US); Sivaram S. Palakodety, San Diego, CA (US); Shenoy H. Gurudutt, San Diego, CA (US); Liang Zhang, San Diego, CA (US)

(73) Assignee: QUALCOMM Incorporated, San Diego, CA (US)

(21) Appl. No.: 13/167,199

(22) Filed: Jun. 23, 2011

Related U.S. Application Data
(60) Provisional application No. 61/358,821, filed on Jun. 25, 2010.

(51) Int. Cl. H04W 72/04

(52) U.S. Cl. 370/329

(57) ABSTRACT

Various aspects of the disclosure provide an intra-Node B unsynchronized serving cell change enabling the typical loss of packets resulting from such a procedure to be reduced or eliminated. In one example, when a UE ceases listening to a downlink channel from a first cell provided by a Node B and starts to configure its receiver to listen to a downlink channel from a second cell provided by the Node B, a continued incrementing of a sequence number may be stalled in the transmission of packets to the UE. That is, the TSN space may be stalled, such that HARQ retransmissions recur beyond the preconfigured maximum number of retransmissions, until the UE indicates that the serving cell change is complete. In another example, the transmission of packets to the UE from the first cell may be halted until the UE indicates that the serving cell change is complete.

### CROSS-REFERENCE TO RELATED APPLICATION

This application claims the benefit of U.S. Provisional Patent Application No. 61/358,821, titled “SYSTEM AND PROCESS FOR TRANSMISSION SEQUENCE NUMBER MANAGEMENT IN AN INTRA-NODE B UNSYNCHRONIZED SERVING CELL CHANGE” and filed on Jun. 25, 2010, the disclosure of which is expressly incorporated by reference herein in its entirety.

### BACKGROUND

1. Field

Aspects of the present disclosure relate generally to wireless communication systems, and more particularly, to intra-Node B unsynchronized serving cell changes.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network defined as a part of the Universal Mobile Telecommunications System (UMTS), a third generation (3G) mobile phone technology specified by the 3rd Generation Partnership Project (3GPP). UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications. For example, as the number of base stations increases, and as the number of cells provided by each base station also increases, handover procedures from one cell to another dramatically increase in frequency. As the number of handovers continues to increase, the importance of improved handover procedures rises. That is, any loss of data caused by handover issues becomes more noticeable when handovers occur more often.

In particular, an intra-Node B synchronized serving cell change typically utilizes a reset procedure to reset the MAC entity, causing internal buffers at the Node B to be flushed and resulting in a loss of packets. Further, an intra-Node B unsynchronized serving cell change, while it may utilize the reset procedure and accordingly lose packets, frequently does not perform the reset and can, in certain circumstances, still result in a substantial loss of packets. Thus, there is a need in the art for an improved handover procedure, for example, for an intra-Node B unsynchronized serving cell change.

### SUMMARY

Various aspects of the disclosure address an issue in an intra-Node B unsynchronized serving cell change (USCC) in an HSPA system, where a transmission sequence number (TSN) wraps around in such a way as to cause numerous issues such as lost or corrupted packets. In various aspects of the present disclosure, the TSN may be stalled during the intra-Node B USCC procedure by extending the number of HARQ retransmissions beyond the configured maximum number of retransmissions until the SCC is complete, or halting scheduling and transmission of packets from the Node B until the SCC is complete.

Some aspects of the present disclosure may relate to wireless user equipment in a cellular telecommunication system. For example, in an exemplary aspect of the disclosure, a method of wireless communication may include utilizing a receiver to receive a first packet having a first sequence number on a first downlink channel from a source cell, reconfiguring the receiver during an unsynchronized intra-Node B serving cell change to receive a second downlink channel from a target cell, and receiving a second packet over the second downlink channel. Here, the second packet may have a second sequence number sequentially incremented from the first sequence number.

In another exemplary aspect of the disclosure, an apparatus for wireless communication may include means for receiving a first packet having a first sequence number on a first downlink channel from a source cell, means for reconfiguring the means for receiving, during an unsynchronized intra-Node B serving cell change, to receive a second downlink channel from a target cell, and means for receiving a second packet over the second downlink channel. Here, the second packet may have a second sequence number sequentially incremented from the first sequence number.

In yet another exemplary aspect of the disclosure, a computer program product may include a computer-readable medium having code for utilizing a receiver to receive a first packet having a first sequence number on a first downlink channel from a source cell, code for reconfiguring the receiver during an unsynchronized intra-Node B serving cell change to receive a second downlink channel from a target cell, and code for receiving a second packet over the second downlink channel. Here, the second packet may have a second sequence number sequentially incremented from the first sequence number.

In yet another exemplary aspect of the disclosure, an apparatus for wireless communication may include at least one processor and a memory coupled to the at least one processor. Here, the at least one processor may be configured to utilize a receiver to receive a first packet having a first sequence number on a first downlink channel from a source cell, to reconfigure the receiver during an unsynchronized intra-Node B serving cell change to receive a second downlink channel from a target cell, and to receive a second packet over the second downlink channel. Here, the second packet may have a second sequence number sequentially incremented from the first sequence number.

Some aspects of the present disclosure may relate to network nodes in a wireless telecommunication system, such as a base station, a radio network controller, a combination of the two, or any other suitable network node or combination of nodes. For example, in an exemplary aspect of the disclosure, a method of wireless communication may include allocating a first sequence number to a first packet to be sent to a UE, transmitting the first packet on a first downlink channel from a source cell to the UE, incrementing the sequence number to a sequential sequence number, allocating the sequential sequence number to a second packet to be sent to the UE, providing a reconfiguration message for a UE to change from the source cell to a target cell, and stalling a continued incrementing of the sequence number until an indication is received from the UE that the change from the source cell to the target cell is complete.

In another exemplary aspect of the disclosure, an apparatus for wireless communication may include means for allocating a first sequence number to a first packet to be sent to a UE, means for transmitting the first packet on a first downlink channel from a source cell to the UE, means for incrementing the sequence number to a sequential sequence number, means for allocating the sequential sequence number to a second packet to be sent to the UE, means for providing a reconfiguration message for a UE to change from the source cell to a target cell, and means for stalling a continued incrementing of the sequence number until an indication is received from the UE that the change from the source cell to the target cell is complete.

In another exemplary aspect of the disclosure, a computer program product may include a computer-readable medium having code for allocating a first sequence number to a first packet to be sent to a UE, code for transmitting the first packet on a first downlink channel from a source cell to the UE, code for incrementing the sequence number to a sequential sequence number, code for allocating the sequential sequence number to a second packet to be sent to the UE, code for providing a reconfiguration message for a UE to change from the source cell to a target cell, and code for stalling a continued incrementing of the sequence number until an indication is received from the UE that the change from the source cell to the target cell is complete.

In another exemplary aspect of the disclosure, an apparatus for wireless communication may include at least one processor and a memory coupled to the at least one processor. Here, the at least one processor may be configured to allocate a first sequence number to a first packet to be sent to a UE, to transmit the first packet on a first downlink channel from a source cell to the UE, to increment the sequence number to a sequential sequence number, to allocate the sequential sequence number to a second packet to be sent to the UE, to provide a reconfiguration message for a UE to change from the source cell to a target cell, and to stall a continued incrementing of the sequence number until an indication is received from the UE that the change from the source cell to the target cell is complete.

These and other aspects of the invention will become more fully understood upon a review of the detailed description, which follows.

### BRIEF DESCRIPTION OF THE DRAWINGS

FIG. 1 is a diagram illustrating an example of a hardware implementation for an apparatus employing a processing system.

FIG. 2 is a block diagram conceptually illustrating an example of a telecommunications system.

FIG. 3 is a conceptual diagram illustrating an example of a radio protocol architecture for the user and control plane.

FIG. 4 is a conceptual diagram illustrating a MAC-hs PDU.

FIG. 5 is a conceptual block diagram illustrating details of a MAC-hs entity.

FIG. 6 is a conceptual diagram illustrating a MAC-ehs PDU.

FIG. 7 is a conceptual block diagram illustrating details of a MAC-ehs entity.

FIG. 8 is a conceptual diagram illustrating an example of an access network.

FIG. 9 is a call flow diagram illustrating an intra-Node B unsynchronized serving cell change procedure.

FIG. 10 is a conceptual block diagram showing lost packets illustrating issues with TSN wrap-around in the prior art.

FIG. 11 is a call flow diagram illustrating an intra-Node B unsynchronized serving cell change procedure in accordance with an exemplary aspect of the disclosure.

FIG. 12 is a block diagram conceptually illustrating an example of a Node B in communication with a UE in a telecommunications system.

FIG. 13 is a flow chart illustrating a process for a UE in an intra-Node B unsynchronized serving cell change procedure in accordance with an exemplary aspect of the disclosure.

FIG. 14 is a flow chart illustrating a process for a UTRAN in an intra-Node B unsynchronized serving cell change procedure in accordance with an exemplary aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

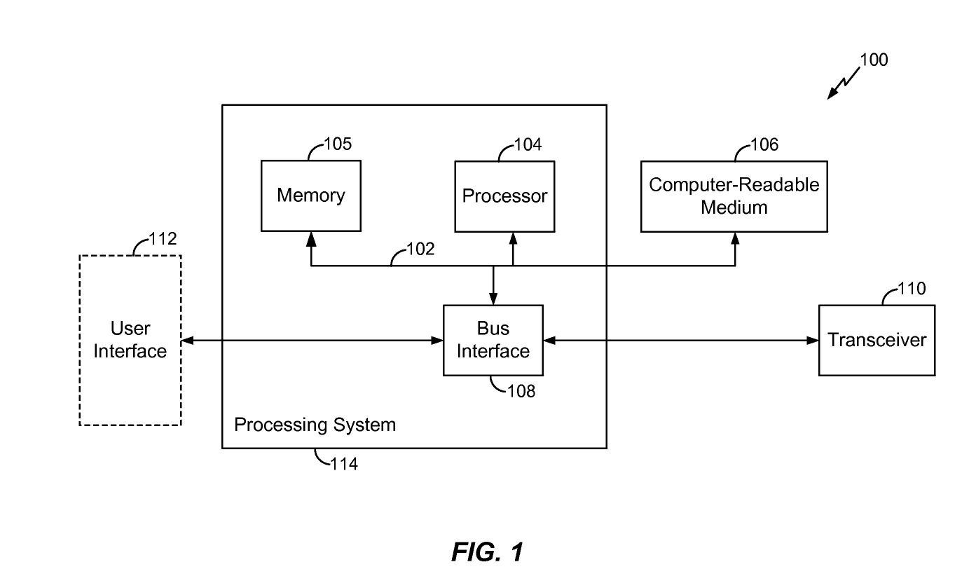

FIG. 1 is a conceptual diagram illustrating an example of a hardware implementation for an apparatus 100 employing a processing system 114. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, a memory 105, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

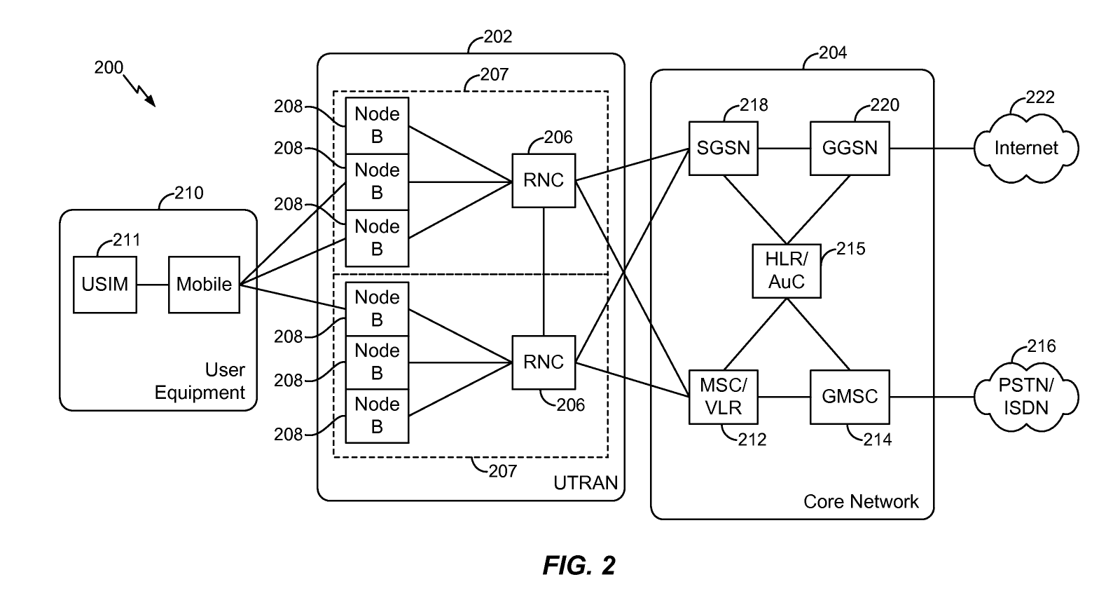

The various concepts presented throughout this disclosure may be implemented across a broad variety of telecommunication systems, network architectures, and communication standards. By way of example and without limitation, the aspects of the present disclosure illustrated in FIG. 2 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. In this example, the UTRAN 202 may provide various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the illustrated RNCs 206 and RNSs 207. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a core network (CN) 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210, and the uplink (UL), also called the reverse link, refers to the communication link from a UE 210 to a Node B 208.

The core network 204 interfaces with one or more access networks, such as the UTRAN 202. As shown, the core network 204 is a GSM core network. However, as those skilled in the art will recognize, the various concepts presented throughout this disclosure may be implemented in a RAN, or other suitable access network, to provide UEs with access to types of core networks other than GSM networks.

The core network 204 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains.

In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The illustrated core network 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

The UMTS air interface may be a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such DS-CDMA technology and additionally calls for a frequency division duplexing (FDD). FDD uses a different carrier frequency for the uplink (UL) and downlink (DL) between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles are equally applicable to a TD-SCDMA air interface.

A high speed packet access (HSPA) air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

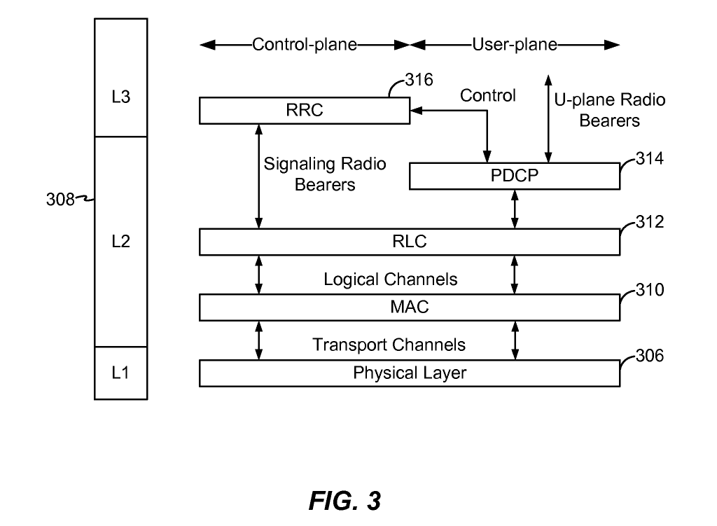

The radio protocol architecture between the UE and the UTRAN may take on various forms depending on the particular application. An example for an HSPA system will now be presented with reference to FIG. 3, illustrating an example of the radio protocol architecture for the user and control planes between a UE and a Node B. Here, the user plane or data plane carries user traffic, while the control plane carries control information, i.e., signaling.

Turning to FIG. 3, the radio protocol architecture for the UE and Node B is shown with three layers: Layer 1, Layer 2, and Layer 3. Layer 1 is the lowest layer and implements various physical layer signal processing functions. Layer 1 will be referred to herein as the physical layer 306. The data link layer, called Layer 2 (L2 layer) 308 is above the physical layer 306 and is responsible for the link between the UE and Node B over the physical layer 306.

At Layer 3, the RRC layer 316 handles the control plane signaling between the UE and the Node B. RRC layer 316 includes a number of functional entities for routing higher layer messages, handling broadcast and paging functions, establishing and configuring radio bearers, etc.

In the UTRA air interface, the L2 layer 308 is split into sublayers. In the control plane, the L2 layer 308 includes two sublayers: a medium access control (MAC) sublayer 310 and a radio link control (RLC) sublayer 312. In the user plane, the L2 layer 308 additionally includes a packet data convergence protocol (PDCP) sublayer 314. Although not shown, the UE may have several upper layers above the L2 layer 308 including a network layer (e.g., IP layer) that is terminated at a PDN gateway on the network side, and an application layer that is terminated at the other end of the connection (e.g., far end UE, server, etc.).

The PDCP sublayer 314 provides multiplexing between different radio bearers and logical channels. The PDCP sublayer 314 also provides header compression for upper layer data packets to reduce radio transmission overhead, security by ciphering the data packets, and handover support for UEs between Node Bs.

The RLC sublayer 312 provides segmentation and reassembly of upper layer data packets, retransmission of lost data packets, and reordering of data packets to compensate for out-of-order reception due to a hybrid automatic repeat request (HARQ).

The MAC sublayer 310 provides multiplexing between logical and transport channels. The MAC sublayer 310 is also responsible for allocating the various radio resources (e.g., resource blocks) in one cell among the UEs. The MAC sublayer 310 is also responsible for HARQ operations.

The MAC sublayer 310 includes various MAC entities, including but not limited to a MAC-d entity and MAC-hs/ehs entity. The Radio Network Controller (RNC) houses protocol layers from MAC-d and above. For the high speed channels, the MAC-hs/ehs layer is housed in the Node B.

From the UE side, The MAC-d entity is configured to control access to all the dedicated transport channels, to a MAC-c/sh/m entity, and to the MAC-hs/ehs entity. Further, from the UE side, the MAC-hs/ehs entity is configured to handle the HSDPA specific functions and control access to the HS-DSCH transport channel. Upper layers configure which of the two entities, MAC-hs or MAC-ehs, is to be applied to handle HS-DSCH functionality.

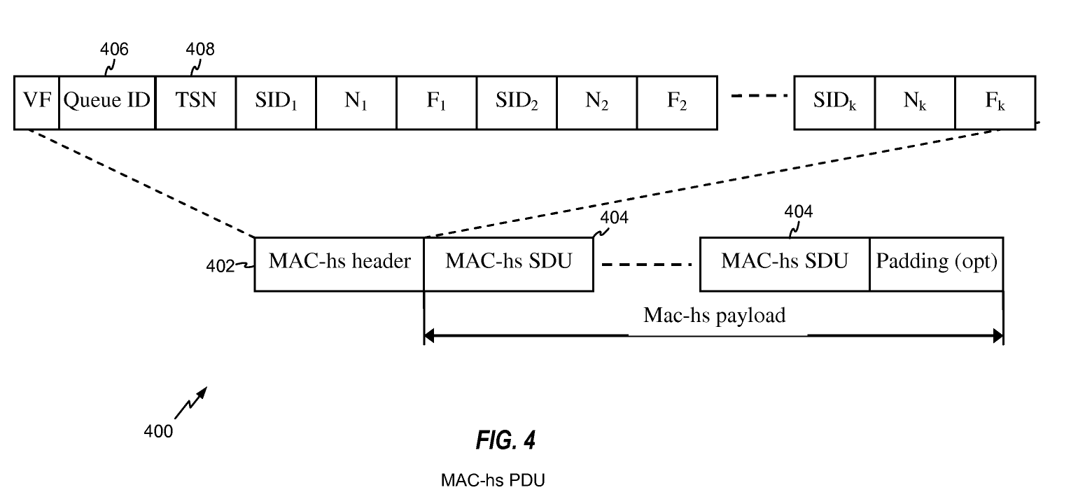

FIG. 4 illustrates an example of a MAC-hs protocol data unit (PDU). When MAC-hs is configured, a MAC PDU for HS-DSCH includes one MAC-hs header 402 and one or more MAC-hs SDUs 404, wherein each MAC-hs SDU 404 may be a MAC-d PDU.

In FIG. 4 the MAC-hs header 402 expanded to show detail. The MAC-hs header 402 is of a variable size. As shown in FIG. 4, the MAC-hs header 402 includes a Transmission Sequence Number (TSN) 408 and queue identifier (QID) 406 associated with each MAC-hs PDU that it transmits. There is a unique QID 406 for each priority queue. The TSNs are sequential for all the packets belonging to a particular priority queue identified by a QID 406. In one example, there can be up to 8 priority queues.

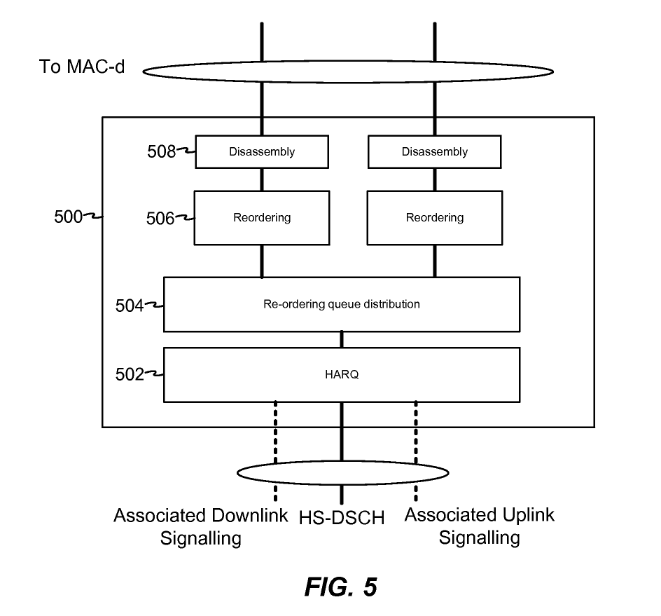

The UE side MAC-hs entity 500 is illustrated in FIG. 5. The MAC-hs entity 500 may include a HARQ entity 502, a reordering queue distribution entity 504, and a plurality of reordering queues each including a reordering entity 506 and a disassembly entity 508.

The HARQ entity 502 is configured to handle MAC functions and tasks related to the HARQ protocol, such as generating ACKs or NACKs. That is, when the Node B transmits a MAC-hs PDU 400 having a particular QID 406 to the UE, the UE may respond as to whether it successfully received the PDU by sending an acknowledgment signal, i.e., a HARQ ACK or NACK. If the PDU was not successfully received, i.e., the Node B received a NACK, the Node B may retransmit part of the symbols that make up the original PDU to the UE, in an attempt to allow recovery of the PDU. The Node B generally keeps retransmitting these further packets until it receives an ACK or reaches a maximum number of allowed retransmissions. After the maximum number is reached, the Node B generally ceases the retransmissions, discards the PDU, and transmits the next PDU with the next sequential TSN to the UE.

Although the UE unsuccessfully decoded a PDU and sent a NACK, the received but unsuccessfully decoded PDU is generally not discarded by the UE. Rather, when retransmissions are received, the UE combines the first unsuccessfully recovered PDU with the retransmissions and performs error correction to recover the contents of the PDU. With each additional retransmission, the probability of recovering the original PDU may increase.

Returning to FIG. 5, the reordering queue distribution entity 504 is configured to route successfully decoded MAC-hs PDUs to the correct reordering buffer based on the QID 406. The reordering entities 506 receive MAC-hs PDUs according to the received TSN 408. Here, MAC-hs PDUs with consecutive TSNs may be delivered to the disassembly entity 508 upon reception. However, if one or more MAC-hs PDUs with a lower TSN than the current PDU are missing, the reordering entity 506 may not deliver the MAC-hs PDUs to the disassembly entity 508.

The disassembly entity 508 is configured to disassemble MAC-hs PDUs. Here, when a MAC-hs PDU is disassembled, the MAC-hs header is removed, the MAC-d PDU is extracted, and any present padding bits are removed. Thus, the MAC-d PDUs can be delivered to a higher layer.

The MAC-ehs entity was standardized with Release 7 of the 3GPP family of standards. The MAC-ehs provides support for flexible RLC PDU sizes, and MAC segmentation and reassembly. The MAC-ehs also provides for the multiplexing of data from several priority queues within one TTI.

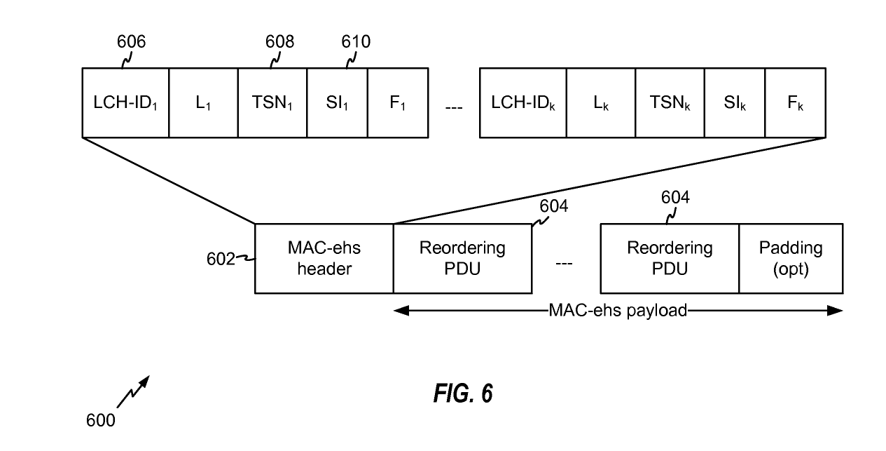

FIG. 6 illustrates a MAC-ehs PDU 600. That is, when MAC-ehs is configured, a MAC PDU for HS-DSCH may include one MAC-ehs header 602 and one or more reordering PDUs 604. The MAC-ehs header 602 is of variable size. Each reordering PDU 604 may include one or more reordering SDUs belonging to the same priority queue. Each reordering SDU may be a MAC-d PDU or a MAC-c PDU.

The MAC-ehs header 602 may include a plurality of logical channel identifiers (LCH-ID) 606, TSNs 608, and system information (SI) bits 610. Here, the QID parameter 406 from MAC-hs has been replaced with the LCH-ID 606. This way, the MAC-ehs entity enables packets from multiple logical channels to be combined into one MAC-ehs packet. Similar to its use in MAC-hs, the TSN 608 is still based on the priority queues. Also similar to the MAC-hs, in MAC-ehs the HARQ retransmissions are based on the TSN numbering.

The LCH-ID 606 and L fields are repeated per reordering SDU. The TSN 608 and SI 610 fields are repeated per reordering PDU 604. Thus, if multiple logical channels are mapped to the same priority queue and they both have packets, then they share the same TSN space. In this case, the TSN 608 and S1610 information for the second reordering PDU 604 will be empty, and the receiver uses the values from the previous reordering PDU 604 of the same MAC-ehs PDU 600. That is, in general, the presence of the TSNᵢ and SIᵢ fields is based on the value of the LCH-IDᵢ; if the LCH-IDᵢ is mapped to the same reordering queue as LCH-IDᵢ₋₁ or if the value of LCH-IDᵢ₋₁ is equal to the value of LCH-IDᵢ, there is no TSNᵢ or SIᵢ field.

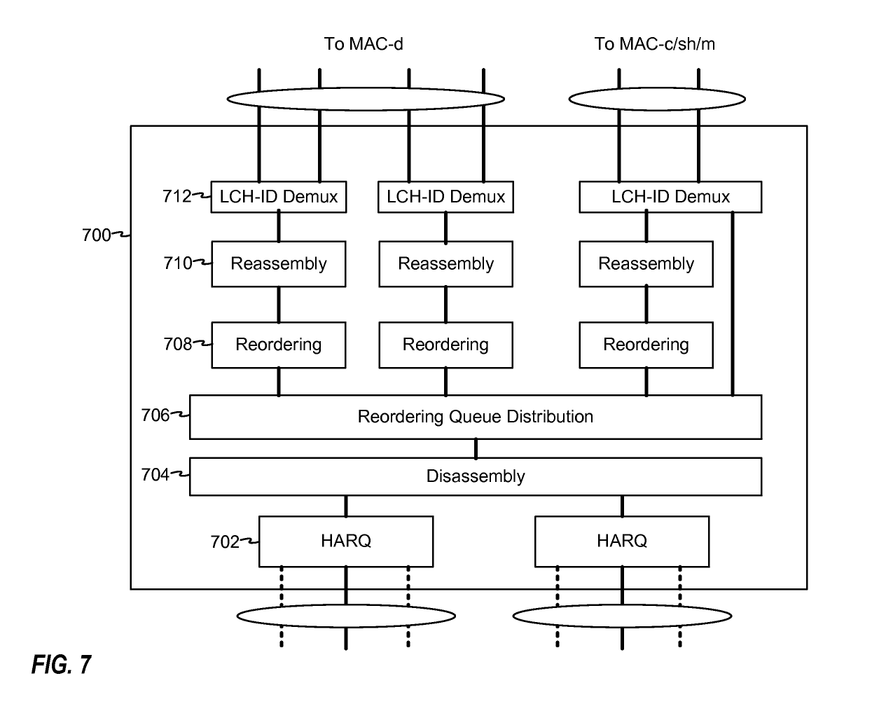

The UE side MAC-ehs entity 700 is illustrated in FIG. 7. The MAC-ehs entity 700 may include a plurality HARQ entities 702, a disassembly entity 704, a re-ordering queue distribution entity 706, and a plurality of re-ordering queues each including a reordering entity 708, a reassembly entity 710, and a LCH-ID demultiplexing entity 712.

There is generally one HARQ entity 702 per HS-DSCH transport channel. The HARQ entity 702 performs substantially the same function as described for the HARQ entity 502 within the MAC-hs entity 500. Further, as shown in FIG. 7, the UE side MAC-ehs has a reordering queue distribution entity 706 configured to route MAC-ehs PDUs to the correct reordering queues based on the received LCH-ID. The reordering entity 708 organizes received reordering PDUs according to the received TSN. Data blocks with consecutive TSNs are then delivered to a reassembly entity 710. A timer mechanism determines delivery of non-consecutive data blocks to higher layers. There is generally one reordering entity 708 for each priority class.

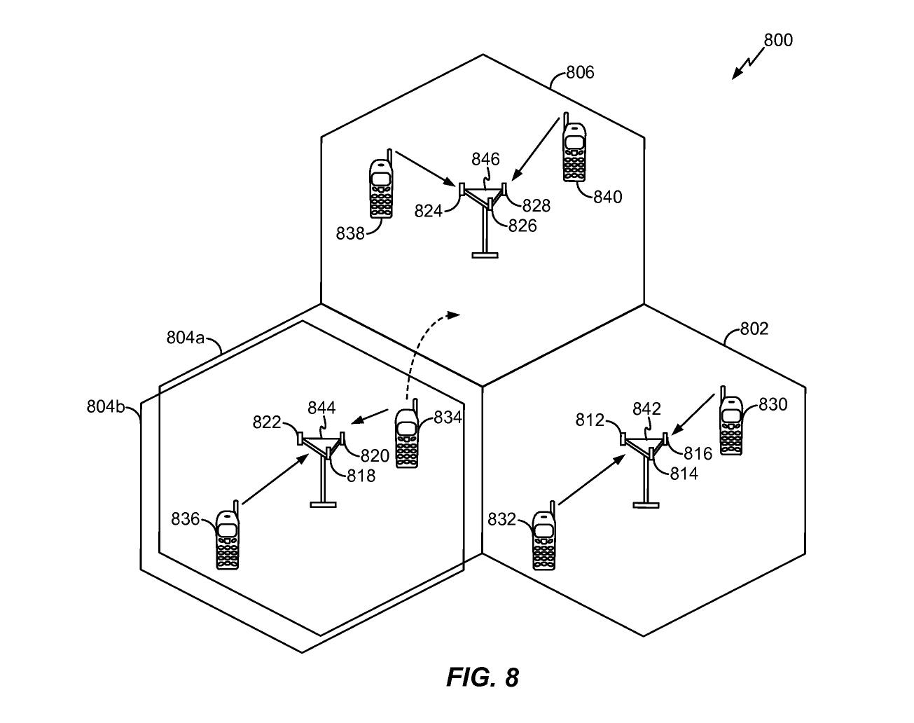

Referring now to FIG. 8, a simplified access network 800 in a UTRAN architecture, which may utilize HSPA, is illustrated. The system includes multiple cellular regions (cells), including cells 802, 804, and 806, each of which may include one or more sectors. Cells may be defined geographically, e.g., by coverage area, and/or may be defined in accordance with a frequency, scrambling code, etc. That is, the illustrated geographically-defined cells 802, 804, and 806 may each be further divided into a plurality of cells, e.g., by utilizing different scrambling codes. For example, cell 804a may utilize a first scrambling code, and cell 804b, while in the same geographic region and served by the same Node B 844, may be distinguished by utilizing a second scrambling code.

In a cell that is divided into sectors, the multiple sectors within a cell can be formed by groups of antennas with each antenna responsible for communication with UEs in a portion of the cell. For example, in cell 802, antenna groups 812, 814, and 816 may each correspond to a different sector. In cell 804, antenna groups 818, 820, and 822 each correspond to a different sector. In cell 806, antenna groups 824, 826, and 828 each correspond to a different sector.

The cells 802, 804 and 806 may include several UEs that may be in communication with one or more sectors of each cell 802, 804 or 806. For example, UEs 830 and 832 may be in communication with Node B 842, UEs 834 and 836 may be in communication with Node B 844, and UEs 838 and 840 may be in communication with Node B 846. Here, each Node B 842, 844, 846 is configured to provide an access point to a core network 204 (see FIG. 2) for all the UEs 830, 832, 834, 836, 838, 840 in the respective cells 802, 804, and 806.

In Release 5 of the 3GPP family of standards, High Speed Downlink Packet Access (HSDPA) was introduced. One difference on the downlink between HSDPA and the previously standardized circuit-switched air-interface is the absence of soft-handover in HSDPA. This means that data is transmitted to the UE from a single cell called the HSDPA serving cell. As the user moves, or as one cell becomes preferable to another, the HSDPA serving cell may change.

In HSDPA, at any instance a UE has one serving cell. Here, a serving cell is that cell on which the UE is camped. According to mobility procedures defined in Release 5 of 3GPP TS 25.331, the Radio Resource Control (RRC) signaling messages for changing the HSPDA serving cell are transmitted from the current HSDPA serving cell (i.e., the source cell), and not the cell that the UE reports as being the stronger cell (i.e., the target cell).

Further, with HSDPA the UE generally monitors and performs measurements of certain parameters of the downlink channel to determine the quality of that channel. Based on these measurements the UE can provide feedback to the Node B on an uplink transmission. This feedback can include a channel quality indicator (CQI). Thus, the Node B may provide subsequent MAC-hs/MAC-ehs packets to the UE on downlink transmissions having a size, coding format, etc., based on the reported CQI from the UE.

For example, during a call with the source cell 804a, or at any other time, the UE 836 may monitor various parameters of the source cell 804a as well as various parameters of neighboring cells such as cells 804b, 806, and 802. Further, depending on the quality of these parameters, the UE 836 may maintain communication with one or more of the neighboring cells. During this time, the UE 836 may maintain an Active Set, that is, a list of cells that the UE 836 is simultaneously connected to (i.e., the UTRA cells that are currently assigning a downlink dedicated physical channel DPCH or fractional downlink dedicated physical channel F-DPCH to the UE 836 may constitute the Active Set).

In a Serving Cell Change (SCC) procedure, the UE requests that the serving cell be changed from the currently serving source cell to a target cell. This request is sent to the UTRAN through a so-called “event 1D” message. The UTRAN and the UE exchange several messages and when the procedure is complete the HS data is served from the target cell.

In accordance with various aspects of the present disclosure, the access network 800 may be a dual cell (DC-HSDPA) system, wherein a single UE is adapted to receive a downlink on each of two carrier frequencies. Further, the access network 800 may be a multi-cell (MC-HSDPA) system, wherein the single UE is adapted to receive a plurality of downlinks, e.g., four or eight downlinks, on different carriers. In accordance with a further aspect of the present disclosure, the access network 800 may be a multi-point HSDPA system (also sometimes called a single frequency dual cell SFDC-HSDPA system or a coordinated multi-point CoMP system), wherein a single UE is adapted to receive a plurality of downlinks from different cells, each provided on the same carrier frequency. In these systems, the plural cells may be provided by the same Node B, or by different Node Bs. In any of these systems, a SCC procedure may involve changing the primary serving cell, one or more secondary serving cells, or a plurality of the serving cells including but not limited to all of the serving cells.

An SCC may be an inter-Node B SCC or an intra-Node B SCC. In the case of an intra-Node B SCC, both the source and the target cells belong to the same Node B (e.g., cells 804a and 804b). In an inter-Node B SCC, the source cell belongs to a different Node B than the target cell.

Further, an SCC may be a synchronized SCC or an unsynchronized SCC. A synchronized SCC is where the RNC tells the UE to change to a new serving cell at a particular time. Here, the Node B and the UE are synchronized such that the Node B knows exactly when the UE will start listening to the new cell. In this case, there is less confusion between the UE and the Node B. In a synchronized SCC, it is generally required to provide adequate time for every type of UE and Node B. Thus, a very conservative assignment of the time for the synchronized SCC is used, perhaps as long as one second. Thus, even though a particular UE may be capable of a faster SCC, the slow, conservative delay is still utilized, potentially resulting in a dropped call where the signal drops quickly.

On the other hand, in an unsynchronized SCC an RRC message called the Physical Channel Reconfiguration message is sent from the RNC to the UE. As soon as the UE receives this message, it starts monitoring the target cell. Once the UE is capable of latching onto the target cell, it sends the Physical Channel Reconfiguration Complete message. Aspects of the present disclosure relate to an improved unsynchronized intra-Node B SCC.

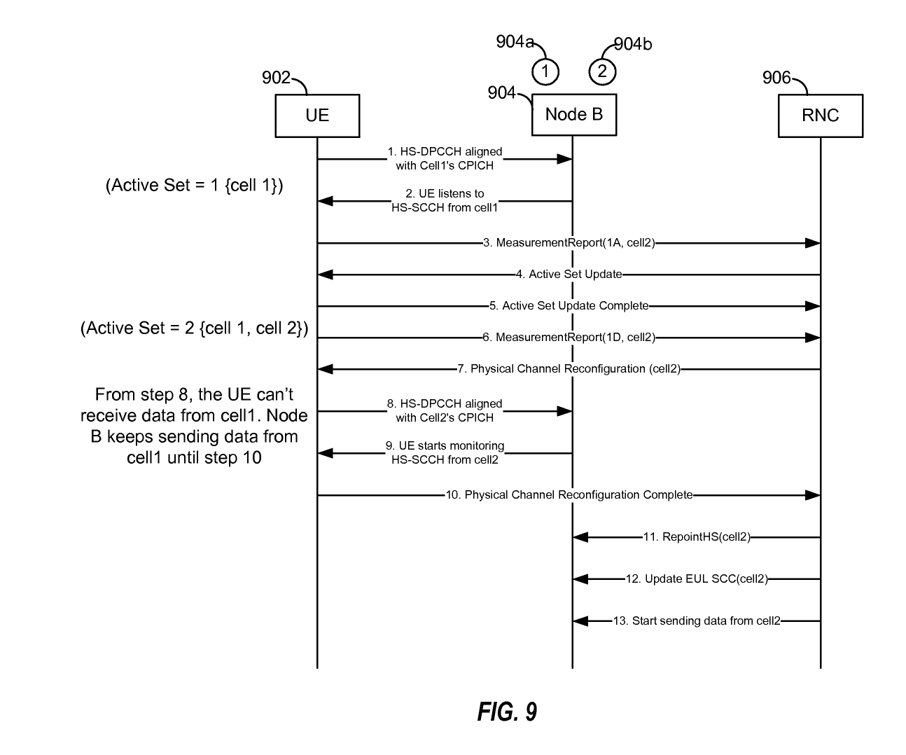

FIG. 9 is a call flow diagram illustrating a conventional unsynchronized intra-Node B SCC procedure. Here, a UE 902 is being handed over from its serving cell (designated as cell 1) 904a to a target cell (designated as cell 2) 904b, both of which are provided by the same Node B 904. For example, cell 1 904a and cell 2 904b may be directionally separated from the Node B 904. The Node B 904 is coupled through an Iub interface to an RNC 906. As described above, as opposed to synchronized SCC, which happens at a predetermined activation time, in an unsynchronized SCC the serving cell change generally happens as soon as possible. Because the UE 902 does not communicate with the Node B 904 or the RNC 906 regarding when the SCC happens, either the UE 902 or the network switches to the target sooner than the other, and hence the UE 902 cannot receive MAC-hs packets. As shown in FIG. 9, the UE 902 switches to the target cell 904b ahead of the Node B 904, and therefore the UE 902 cannot receive any packets from the source cell 904a.

Referring to FIG. 9, in step 1, the HS-DPCCH of the UE 902 is aligned with the CPICH of cell 1 904a, the source serving cell associated with the Node B 904. Thus, in step 2, the UE 902 is configured to receive and decode the HS-SCCH from cell 1 904a. At this point, the Active Set for the UE 902 includes one cell, that is, cell 1, 902a. Meanwhile, the UE 902 may perform regular monitoring and measurements of signal conditions of neighboring cells, such as cell 2 904b, which is also broadcast from the Node B 904.

Based on the measurements made by the UE 902, a signal quality of cell 2 904b may cross a certain threshold. In this case, in step 3, the UE 902 provides an RRC Measurement Report message including “event 1A” to the RNC 906, requesting that cell 2 904b be added to the Active Set for the UE 902. In response, in step 4, the RNC 906 provides an Active Set Update command to the UE. With the Active Set Update Complete message sent by the UE 902 in step 5, the Active Set for the UE 902 includes two cells, that is, cell 1 904a and cell 2 904b.

At some point in time the signal quality of cell 2 904b may exceed that of cell 1 904a, at which time the UE 902 may wish to have cell 2 904b become its serving cell. Thus, based on further measurements that indicate that cell 2 904b is better than cell 1 904a, in step 6 the UE 902 may provide a Measurement Report message including “event 1D” to the RNC 906, requesting a serving cell change to cell 2 904b. In response, in step 7 the RNC 906 may provide a Physical Channel Reconfiguration message to the UE 902 indicating that the UE 902 may change its serving cell to cell 2 904b.

At this point, based on information from the network in step 7, in step 8 the UE 902 begins to align its HS-DPCCH with the CPICH of cell 2 904b, so that the UE 902 may monitor the target cell 904b. Thus, the UE 902 stops listening to cell 1 904a, and any information transmitted from cell 1 904a and directed to the UE 902 is not received.

In step 9, after successfully aligning with the target cell 904b, the UE 902 starts monitoring the HS-SCCH from cell 2 904b. In step 10, the UE 902 provides a Physical Channel Reconfiguration Complete message to the RNC 906 indicating that the UE 902 is ready to receive packets from cell 2 904b. In steps 11 and 12, the RNC 906 configures cell 2 904b for Enhanced Uplink (EUL) communication with the UE 902. Finally, in step 13, the Node B 904 is configured to begin sending data from cell 2 904b.

During the time between step 8, when the UE 902 ceases listening for data from cell 1 904a, and step 10, when the UE 902 indicates that it is configured and ready to receive packets from cell 2 904b, the RNC 906 may still believe that the UE 902 is listening for data from cell 1 904a, and thus the Node B 904 may continue transmitting packets to the UE 902 from cell 1 904a. When those packets are not acknowledged, after a certain time, the network transmits a number of retransmission packets directed to the UE 902 from cell 1 904a. When a maximum number of these retransmissions is not acknowledged, since the UE 902 is not listening for them, the network stops trying to send that packet, increments the transmission sequence number (TSN), and attempts to transmit the next packet. Thus, depending on the length of time it takes for the UE 902 to become ready to receive from cell 2 904b and to indicate in step 10 that it is ready, a number of packets may be lost, and the TSN may be incremented a corresponding number of times.

During a SCC procedure the UTRAN has the option of either continuing the previous MAC-hs TSN sequence or resetting it. This information is communicated to the UE in one of the Layer 3 messages. If the MAC-hs/MAC-ehs is reset, the TSN starts from 0 for all the priority queues when the target cell starts transmitting. If MAC-hs/MAC-ehs is not reset, the TSN numbering is continued for all the priority queues from the source cell. In an intra-Node B SCC, because the MAC-hs packets are sent from the same Node B, the TSNs are continued and the MAC-hs/MAC-ehs is generally not reset. As discussed below, this may result in a number of issues during the time when the UE is listening to the target cell, yet packets are still being provided from the source cell.

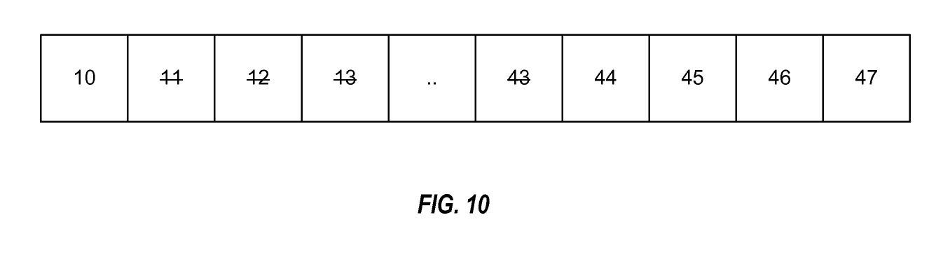

FIG. 10 shows one example of a series of TSNs at a UE during an intra-Node B unsynchronized SCC. In this example, referring to FIGS. 9 and 10, imagine that TSN 10 is the last successfully received MAC-hs/MAC-ehs packet on the HS-DSCH transmitted from the source serving cell 904a. After receiving the packet with the TSN 10, the UE 902 started reconfiguring to the target cell 904b and therefore failed to decode the immediately following packets that continued to be transmitted from the source serving cell 904a. That is, because the SCC is unsynchronized, the source serving cell 904a continues to send packets having the sequential TSNs. For each of these packets, the Node B 904 attempts to send the maximum number of configured transmissions, and after not receiving the ACK, moves on to the next packet.

In one example, a MAC-hs/MAC-ehs packet is retransmitted for a maximum of 1 time and the reconfiguration time is 132 ms. In this example, with 132 ms and 4 ms per packet (first time+1 retransmission), this comes to missing 33 TSNs (132/4). In FIG. 10, the missed packets are indicated by the stricken-through TSNs 11-43. However, because this example utilizes a 6-bit TSN that is capable only of counting 64 numbers (from 0 to 63), if the TSN jumps by more than 32 between two successfully received packets, the UE 902 may become confused and assume that the next 32 packets are repeats of already-received packets. Thus, the UE 902 may throw away these packets.

At the UE, a state variable called RcvWindow_UpperEdge (corresponding to the last received MAC PDU, which has the highest TSN of all received MAC PDUs) would have been 10 when the UE received a packet from the target cell having TSN 44. Assuming there were no holes in the TSN space, a state variable for the UE called Next_expected_TSN (corresponding to the TSN following the TSN of the last in-sequence MAC PDU received) would be 11. The lower edge of the receive window would have been 43 (RcvWindow_UpperEdge−RECEIVE_WINDOW_SIZE+1, where RECEIVE_WINDOW_SIZE is a parameter at the UE, configured by higher layers). Thus, the receive window would have been (42, 10). Because TSN 44 falls within this receive window, the receive window will continue to be (42, 10), even after receiving TSN 44. Further, because 44 falls within the receive window and is less than the Next_expected_TSN, the UE would assume that the next packet is a repeat of the previously received packet having a TSN 44, and thus it will be dropped by the UE. Further, all the following packets from 44 to 10 (wherein the TSN wraps around after reaching its maximum of 63) will also be dropped for the same reason. Once a packet having the TSN 11 is received by the UE, it is combined with the previous packet having the TSN 10, and a wrong RLC PDU is formed. Furthermore, if there were holes in the TSN space from (41, 10), then a new packet fills that hole and another wrong RLC PDU is formed. Thus, it is seen that the conventional intra-Node B unsynchronized SCC can potentially be very problematic. The TSN wrap around issue described above generally arises when the 6-bit TSN changes by more than 32 numbers without the UE receiving any packets, such that the next received packet falls within the receive window.

Various issues can arise due to the TSN wrap around issue. For example, the packets that went through the maximum number of HARQ retransmissions until the Node B gave up transmitting those packets, are later required to go through RLC retransmissions. Further, a number of newly transmitted packets will be dropped and would also result in RLC level retransmission. Still further, the reassembly layer may assemble wrong packets resulting in further errors at the RLC and higher layers.

In order to address this TSN wrap around issue, various aspects of the present disclosure may stall the TSN space during the intra-Node B unsynchronized SCC, such that the Node B continues to send retransmissions of a packet beyond the maximum number of retransmissions, and does not advance to the next TSN until an ACK is received or the unsynchronized SCC is complete. In various other aspects of the disclosure, the network may stop scheduling packets to the UE during the intra-Node B unsynchronized SCC, such that packets are not transmitted to the UE until the unsynchronized SCC is complete.

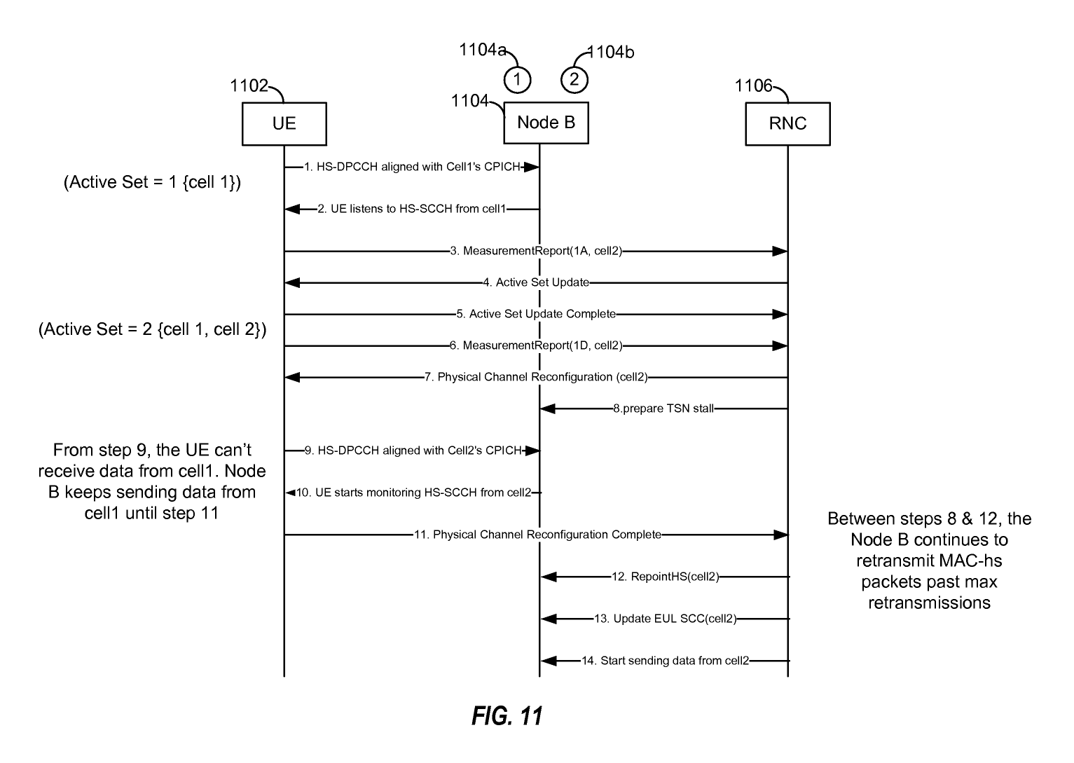

FIG. 11 is a call flow diagram illustrating a process of stalling the TSN space during the intra-Node B unsynchronized SCC according to an aspect of the disclosure. Here, a UE 1102 undergoes an unsynchronized SCC between cell 1, 1104a, and cell 2, 1104b, both of which are provided by the same Node B 1104. The Node B 1104 is coupled to an RNC 1106 by way of an Iub interface.

In the illustrated example, steps numbered 1-7 are substantially the same as steps numbered 1-7 in FIG. 9, and are therefore not described here in detail. At the end of step 7, the UE 1102 has received a Physical Channel Reconfiguration message indicating that the UE 1102 may change its serving cell to cell 2, 1104b.

Some aspects of the disclosure may address the TSN wrap-around issue by stalling the TSN space from the time when the Physical Channel Reconfiguration (PCR) message (sent from the RNC 1106 in step 7) is sent to the UE 1102 until the Physical Channel Reconfiguration Complete (PCRC) message (sent from the UE 1102 11) is sent to the RNC 1106. That is, in step 8, the RNC 1106 may send information to the Node B 1104 to prepare the Node B 1104 to stall the TSN space.

Therefore, in one aspect of the disclosure, during this period after the Node B 1104 receives this message from the RNC 1106, the Node B 1104 may continue to retransmit HARQ packets beyond the maximum number of HARQ retransmissions that it communicated to the UE. That is, in step 9, the UE begins to align its HS-DPCCH with the CPICH of ce112, 1104b, so that in step 10, the UE 1102 may monitor the target cell 1104b. Thus, the UE stops listening to cell 1, 1104a, and any packet sent from cell 1 addressed to the UE 1102 may not be acknowledged with a HARQ ACK/NACK.

In a conventional system, the Node B transmits packets to the UE when it receives channel quality information (CQI) from the UE. This way, the Node B can adapt the transmissions to the UE in accordance with the channel as seen by the UE. However, the Node B is not generally required only to transmit packets to the UE when it receives the CQI. That is, in accordance with some aspects of the disclosure, the Node B may continue transmitting retransmissions of MAC PDUs to the UE despite failing to receive feedback from the UE in the form of HARQ ACK/NACK or CQI information. Thus, in some aspects of the present disclosure, the Node B may utilize a previously-received CQI value to configure transmissions to the UE. This re-use of previous CQI values may continue indefinitely (i.e., until the Node B receives feedback such as a HARQ ACK/NACK and/or a CQI from the UE), or may continue for a predetermined number of transmissions or retransmissions.

Returning to FIG. 11, in accordance with the information received from the RNC 1106 in step 8, the MAC layer in the Node B 1104 may be reconfigured to continue HARQ retransmissions of the packet sent from cell 1, 1104a, even if the maximum number of HARQ retransmissions has been reached. In this way, the queue of packets may be blocked, so that the TSNs are not incremented, and the retransmissions of the missed PDU continue.

In step 11, the UE 1102 provides a PHYSICAL CHANNEL RECONFIGURATION COMPLETE message to the RNC 1106, indicating that it is ready to receive the HS-SCCH from cell 2, 1104b. Thus, in steps 12 and 13, the RNC configures cell 2, 1104b, for Enhanced Uplink (EUL) communication with the UE 1102, and in step 14, the RNC 1106 directs the Node B 1104 to start sending data from cell 2, 1104b. At this point, the Node B 1104 may reschedule the packet undergoing retransmission at cell 1, 1104a, to be transmitted from cell 2, 1104b, or may cease retransmissions and begin transmission of the subsequent packet from cell 2, 1104b.

In a conventional network, the scheduler generally treats HARQ retransmissions as higher priority than new data. However, in a further aspect of the instant disclosure, once the maximum number of transmissions is reached, the retransmissions may be treated as having the same priority as new packets destined for some other UEs. Because these retransmitted packets have the same priority as initially transmitted packets to other UEs, these retransmitted packets will not hog the HS-PDSCH channel.

By stopping the Node B from incrementing the TSN, various aspects of the disclosure address a number of issues discussed above. For example, the number of unnecessarily dropped new MAC-hs packets may be reduced or eliminated. Further, unnecessary RLC retransmissions may be reduced or eliminated. Even further, the incorrectly assembled RLC PDU should not occur.

In another aspect of the disclosure, rather than continuing retransmissions between steps 7 and 11, the TSN stall may instead cause the Node B 1104 to cease transmissions to the UE 1102 until the handover to cell 2, 1104b, is completed. This may reduce overhead, and achieve the same result as continuing the retransmissions.

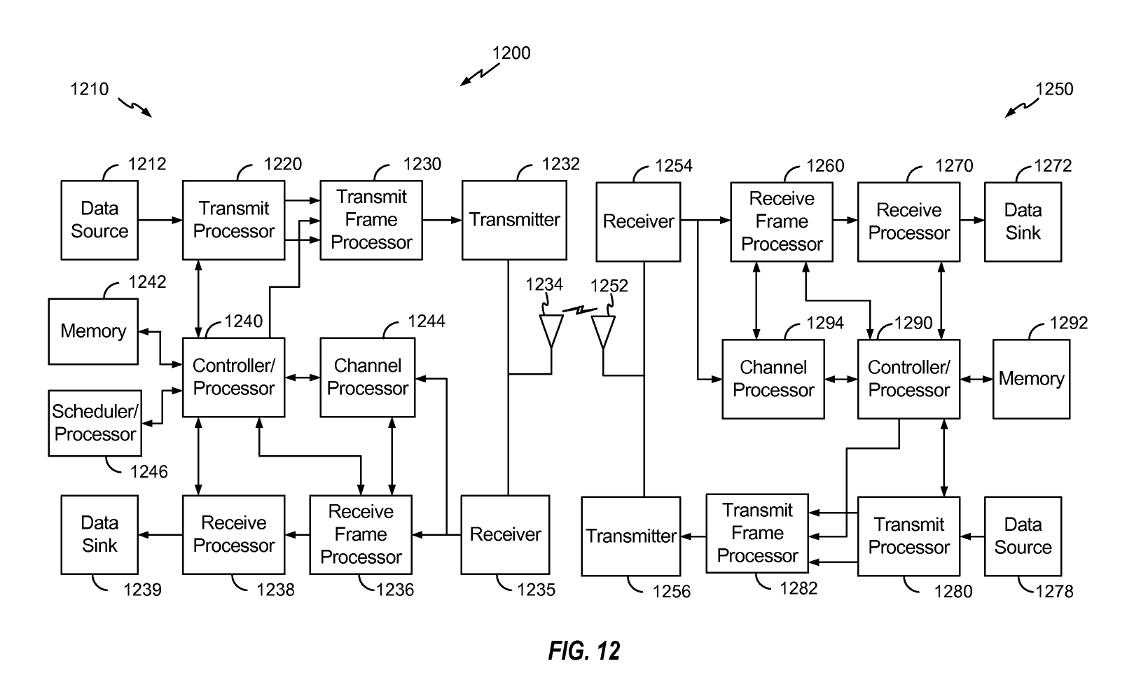

FIG. 12 is a block diagram of an exemplary Node B 1210 in communication with a UE 1250, where the Node B 1210 may be the Node B 208 in FIG. 2, and the UE 1250 may be the UE 210 in FIG. 2. In the downlink communication, a transmit processor 1220 may receive data from a data source 1212 and control signals from a controller/processor 1240. The transmit processor 1220 provides various signal processing functions for the data and control signals, as well as reference signals (e.g., pilot signals). For example, the transmit processor 1220 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1244 may be used by a controller/processor 1240 to determine the coding, modulation, spreading, and/or scrambling schemes for the transmit processor 1220. These channel estimates may be derived from a reference signal transmitted by the UE 1250 or from feedback from the UE 1250. The symbols generated by the transmit processor 1220 are provided to a transmit frame processor 1230 to create a frame structure. The transmit frame processor 1230 creates this frame structure by multiplexing the symbols with information from the controller/processor 1240, resulting in a series of frames. The frames are then provided to a transmitter 1232, which provides various signal conditioning functions including amplifying, filtering, and modulating the frames onto a carrier for downlink transmission over the wireless medium through antenna 1234. The antenna 1234 may include one or more antennas, for example, including beam steering bidirectional adaptive antenna arrays or other similar beam technologies.

At the UE 1250, a receiver 1254 receives the downlink transmission through an antenna 1252 and processes the transmission to recover the information modulated onto the carrier. The information recovered by the receiver 1254 is provided to a receive frame processor 1260, which parses each frame, and provides information from the frames to a channel processor 1294 and the data, control, and reference signals to a receive processor 1270. The receive processor 1270 then performs the inverse of the processing performed by the transmit processor 1220 in the Node B 1210. More specifically, the receive processor 1270 descrambles and despreads the symbols, and then determines the most likely signal constellation points transmitted by the Node B 1210 based on the modulation scheme. These soft decisions may be based on channel estimates computed by the channel processor 1294. The soft decisions are then decoded and deinterleaved to recover the data, control, and reference signals. The CRC codes are then checked to determine whether the frames were successfully decoded. The data carried by the successfully decoded frames will then be provided to a data sink 1272, which represents applications running in the UE 1250 and/or various user interfaces (e.g., display). Control signals carried by successfully decoded frames will be provided to a controller/processor 1290. When frames are unsuccessfully decoded by the receiver processor 1270, the controller/processor 1290 may also use an acknowledgement (ACK) and/or negative acknowledgement (NACK) protocol to support retransmission requests for those frames.

In the uplink, data from a data source 1278 and control signals from the controller/processor 1290 are provided to a transmit processor 1280. The data source 1278 may represent applications running in the UE 1250 and various user interfaces (e.g., keyboard) Similar to the functionality described in connection with the downlink transmission by the Node B 1210, the transmit processor 1280 provides various signal processing functions including CRC codes, coding and interleaving to facilitate FEC, mapping to signal constellations, spreading with OVSFs, and scrambling to produce a series of symbols. Channel estimates, derived by the channel processor 1294 from a reference signal transmitted by the Node B 1210 or from feedback contained in the midamble transmitted by the Node B 1210, may be used to select the appropriate coding, modulation, spreading, and/or scrambling schemes. The symbols produced by the transmit processor 1280 will be provided to a transmit frame processor 1282 to create a frame structure. The transmit frame processor 1282 creates this frame structure by multiplexing the symbols with information from the controller/processor 1290, resulting in a series of frames. The frames are then provided to a transmitter 1256, which provides various signal conditioning functions including amplification, filtering, and modulating the frames onto a carrier for uplink transmission over the wireless medium through the antenna 1252.

The uplink transmission is processed at the Node B 1210 in a manner similar to that described in connection with the receiver function at the UE 1250. A receiver 1235 receives the uplink transmission through the antenna 1234 and processes the transmission to recover the information modulated onto the carrier. The information recovered by the receiver 1235 is provided to a receive frame processor 1236, which parses each frame, and provides information from the frames to the channel processor 1244 and the data, control, and reference signals to a receive processor 1238. The receive processor 1238 performs the inverse of the processing performed by the transmit processor 1280 in the UE 1250. The data and control signals carried by the successfully decoded frames may then be provided to a data sink 1239 and the controller/processor, respectively. If some of the frames were unsuccessfully decoded by the receive processor, the controller/processor 1240 may also use an acknowledgement (ACK) and/or negative acknowledgement (NACK) protocol to support retransmission requests for those frames.

The controller/processors 1240 and 1290 may be used to direct the operation at the Node B 1210 and the UE 1250, respectively. For example, the controller/processors 1240 and 1290 may provide various functions including timing, peripheral interfaces, voltage regulation, power management, and other control functions. The computer readable media of memories 1242 and 1292 may store data and software for the Node B 1210 and the UE 1250, respectively. A scheduler/processor 1246 at the Node B 1210 may be used to allocate resources to the UEs and schedule downlink and/or uplink transmissions for the UEs.

It is to be understood that the specific order or hierarchy of steps in the methods disclosed hereinbelow is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

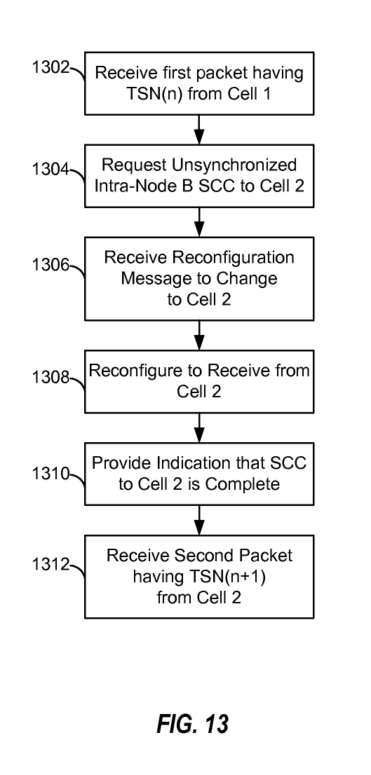

FIG. 13 is a flow chart illustrating an exemplary method or process for wireless communication in accordance with some aspects of the present disclosure. For example, the process illustrated in FIG. 13 may be implemented by a processing system 100 as illustrated in FIG. 1; by the UE 210 illustrated in FIG. 2, or the UE 1250 illustrated in FIG. 12, or by any other suitable apparatus for wireless communication. In block 1302, the process may receive a first packet (e.g., a MAC PDU) from a source cell. The first packet may include a first TSN, and may arrive on a first downlink channel from the source cell, e.g., the HS-DSCH.

Here, as described above, the UE may have a plurality of cells in its Active Set. Further, the UE may measure various characteristics of neighboring cells, and if one or more neighboring cells in the Active Set has a characteristic such as a pilot power greater than a certain threshold, then in block 1302 the process may provide a Measurement Report message including event 1D, requesting that the serving cell be changed from the source cell to a target cell, e.g., cell 2. In response, in block 1306 the network may provide a Physical Channel Reconfiguration message to the UE, indicating for the UE to reconfigure its receiver to listen to the target cell, i.e., cell 2. Thus, in block 1308 the process may reconfigure the receiver of the UE during the unsynchronized intra-Node B SCC to receive a downlink channel (e.g., the HS-DSCH) from the target cell, i.e., cell 2. When the receiver of the UE is configured to monitor the HS-SCCH from the target cell, i.e., cell 2, in block 1310 the process may provide an indication from the UE that the SCC from the source cell, cell 1, to the target cell, cell 2, is complete. For example, the UE may transmit a Physical Channel Reconfiguration Complete message to the RNC.

Upon reception of the indication that the SCC is complete, the network may reconfigure the Node B such that further transmissions on the downlink HS-DPCCH come from the target cell, i.e., cell 2. Here, in step 1312, a packet (e.g., a MAC PDU) transmitted from the target cell may have a sequence number that is sequentially incremented from the first sequence number. That is, if the first packet, received just prior to the reconfiguration of the receiver, had a TSN of n, then the second packet, received after the SCC is complete, may have a TSN of n+1. In this way, the TSN wrap-around issue described above may be avoided.

In some aspects of the disclosure, the second packet may have been unsuccessfully transmitted from the source cell, i.e., cell 1, after the time that the UE reconfigured to receive from the target cell, i.e., cell 2. Thus, the second packet may have undergone HARQ retransmissions. In accordance with an aspect of the present disclosure, the TSN space may have been halted, and therefore, the second packet may have undergone HARQ retransmissions beyond the preconfigured maximum number of HARQ retransmissions. In a further aspect of the disclosure, a counter for counting the number of HARQ retransmissions for the second packet may be reset after the UE provides a Physical Channel Reconfiguration Complete message to indicate that the receiver of the UE was reconfigured to receive the HS-DPCCH from the target cell, i.e., cell 2.

In other aspects of the disclosure, the second packet transmitted after the UE reconfigured its receiver to monitor the HS-DPCCH from the target cell, may have been delayed. That is, the transmission of the second packet may have been stalled until after the UE provided the Physical Channel Reconfiguration Complete message to indicate that the receiver of the UE was reconfigured to receive the HS-DPCCH from the target cell, i.e., cell 2. In this fashion the TSN wrap-around issue discussed above may be avoided.

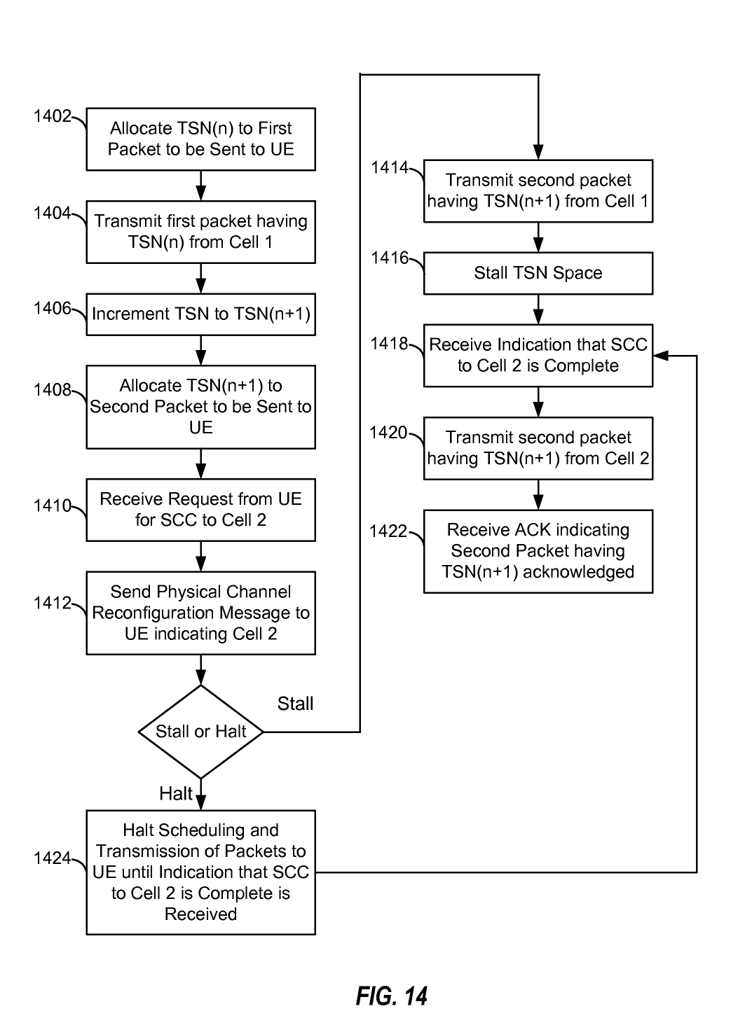

FIG. 14 is a flow chart illustrating another exemplary process for wireless communication in accordance with some aspects of the present disclosure. For example, the process illustrated in FIG. 14 may be implemented by a processing system 100 as illustrated in FIG. 1; by the Node B 208 illustrated in FIG. 2 or the Node B 1210 illustrated in FIG. 12; by the RNC 206 illustrated in FIG. 2; by a combination of a Node B and an RNC; or by any suitable apparatus for wireless communication.

In block 1402, the process may allocate a TSN having number n to a first packet, e.g., a MAC PDU, to be sent to a UE. The allocation may take place at the Node B, at the RNC, or at any other suitable node in the network. If the allocation is performed at a node other than the Node B, then the PDU is provided to the Node B for transmission to the UE. In block 1404, the first packet, having the TSN of n is transmitted to the UE from a first cell of a plurality of cells provided by the Node B. Following receipt of a HARQ acknowledgment of the packet, in block 1406 the process increments the TSN to n+1, and in block 1408 the process allocates the TSN of n+1 to a second packet to be transmitted to the UE.

Meanwhile, the UE may be moving and/or signal conditions may be changing. As such, the UE may decide that another cell provided by the Node B, say cell 2, is preferable, and may request a SCC to cell 2. Thus, in block 1410, the process may receive a Measurement Report message including event 1D, requesting that the serving cell be changed from cell 1 to cell 2. In response, the network may determine to hand over the UE from cell 1 to cell 2, utilizing an intra-Node B unsynchronized SCC. That is, in block 1412, the process may send a Physical Channel Reconfiguration message to the UE ordering the UE to change to cell 2, thereby causing the UE to stop listening to the HS-PDCCH provided from cell 1.

In some implementations in accordance with the disclosure, the process may be configured to stall the TSN space in accordance with the intra-Node B unsynchronized SCC. That is, in block 1414, the process may continue to attempt to transmit the PDU having the TSN n+1 to the UE utilizing cell 1, at the time prior to completion of the intra-Node B unsynchronized SCC. However, because the UE is no longer monitoring the cell 1, the Node B may not receive a HARQ ACK/NACK from the UE. Thus, the network may attempt HARQ retransmissions of the packet. Here, in block 1416, the process may stall the TSN space. That is, the process may stall incrementing the TSNs and may continue retransmissions of the packet having TSN of n+1 beyond the predetermined maximum number of retransmissions.

In other implementations in accordance with the disclosure, the process may be configured to halt the scheduling and transmission of packets to the UE until the intra-Node B unsynchronized SCC is complete. That is, in block 1424, after sending the Physical Channel Reconfiguration message to the UE ordering the UE to switch its serving cell to cell 2, the process may halt further transmissions to the UE from the Node B that provides cell 1 and cell 2, and concomitantly halt scheduling additional packets to the UE. This way, the process may avoid any TSN wrap-around issues. When the process receives in block 1418 the Physical Channel Reconfiguration Complete message from the UE indicating that the SCC to cell 2 is complete, then in block 1420, the process may transmit the packet having the TSN of n+1 from cell 2.

After the SCC is complete and the Node B has transmitted from cell 2 the packet having the TSN of n+1, in block 1422 the process may receive a HARQ ACK/NACK corresponding to the packet having the TSN of n+1. Thus, normal processing may continue, and the TSN wrap-around issue may be avoided.

Referring now once again to FIG. 12, in one configuration, the apparatus 1250 for wireless communication may include means for receiving packet(s) or any of various messages from one or more cells, and means for reconfiguring a receiver to receive from a suitable sell, e.g., in accordance with a SCC procedure. For example, the aforementioned means may include the receiver 1254, the receive frame processor 1260, the receive processor 1270, the channel processor 1294, and/or the controller/processor 1290. In another example, the aforementioned means may include the processing system 114 illustrated in FIG. 1 configured to perform the functions recited by the aforementioned means. Further, the apparatus 1250 may include means for requesting an unsynchronized intra-Node B SCC, means for providing indications that a SCC procedure is complete, and means for transmitting these or any other suitable message. For example, the aforementioned means may include the transmitter 1256, the transmit frame processor 1282, the transmit processor 1280, and/or the controller/processor 1290. In another example, the aforementioned means may include the processing system 114 illustrated in FIG. 1 configured to perform the functions recited by the aforementioned means.

In another configuration, the apparatus 1210 for wireless communication may include means for allocating TSNs to packets, e.g., MAC-hs and/or MAC-ehs PDUs, means for incrementing a TSN or changing a TSN in any suitable manner to be allocated to a packet, means for stalling the TSN space, and/or means for stopping the scheduling of packets to the UE during the intra-Node B unsynchronized SCC procedure. In one aspect, the aforementioned means may be the channel processor 1244, the controller/processor 1240, and/or the scheduler/processor 1246 configured to perform the functions recited by the aforementioned means. In another aspect, the aforementioned means may include the processing system 114 illustrated in FIG. 1 configured to perform the functions recited by the aforementioned means. Further, the apparatus 1210 may include means for transmitting packets, e.g., MAC-hs and/or MAC-ehs PDUs, and means for sending any of various messages to one or more UEs. In one aspect, the aforementioned means may include the transmitter 1232, the transmit frame processor 1230, the transmit processor 1220, the controller/processor 1240, and/or the scheduler/processor 1246 configured to perform the functions recited by the aforementioned means. In another aspect, the aforementioned means may include the processing system 114 illustrated in FIG. 1 configured to perform the functions recited by the aforementioned means. Further, the apparatus 1210 may include means for receiving packets from one or more UEs, and means for receiving any of various requests and messages from one or more UEs, including but not limited to HARQ ACK/NACK messages and RRC messages. In one aspect, the aforementioned means may include the receiver 1235, the receive frame processor 1236, the receive processor 1238, the channel processor 1244, the controller/processor 1240, and/or the scheduler/processor 1246 configured to perform the functions recited by the aforementioned means. In another aspect, the aforementioned means may include the processing system 114 illustrated in FIG. 1 configured to perform the functions recited by the aforementioned means.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method of wireless communication, comprising:
allocating a first sequence number to a first packet to be sent to a UE;
transmitting the first packet on a first downlink channel from a source cell to the UE;
incrementing the sequence number to a sequential sequence number;
allocating the sequential sequence number to a second packet to be sent to the UE;
providing a reconfiguration message for a UE to change from the source cell to a target cell; and
stalling a continued incrementing of the sequence number until an indication is received from the UE that the change from the source cell to the target cell is complete.

2. The method of claim 1, further comprising transmitting HARQ retransmissions of the second packet beyond a preconfigured maximum number of HARQ retransmissions.

3. The method of claim 2, further comprising allocating a priority to the HARQ retransmissions of the second packet beyond the preconfigured maximum number of HARQ retransmissions, the priority being the same priority as that assigned to at least one new packet directed to a second UE.

4. The method of claim 2, further comprising adapting the transmission of the HARQ retransmissions in accordance with a channel quality indication received from the UE prior to the providing of the reconfiguration message.

5. The method of claim 1, further comprising halting scheduling of packets to the UE after the providing of the reconfiguration message, until the indication is received from the UE that the change from the source cell to the target cell is complete.

6. The method of claim 1, wherein the stalling of the continued incrementing comprises halting transmission of packets to the UE until an indication is received that the change from the source cell to the target cell is complete.

7. An apparatus for wireless communication, comprising:
means for allocating a first sequence number to a first packet to be sent to a UE;
means for transmitting the first packet on a first downlink channel from a source cell to the UE;
means for incrementing the sequence number to a sequential sequence number;
means for allocating the sequential sequence number to a second packet to be sent to the UE;
means for providing a reconfiguration message for a UE to change from the source cell to a target cell; and
means for stalling a continued incrementing of the sequence number until an indication is received from the UE that the change from the source cell to the target cell is complete.

8. The apparatus of claim 7, further comprising means for transmitting HARQ retransmissions of the second packet beyond a preconfigured maximum number of HARQ retransmissions.

9. The apparatus of claim 8, further comprising means for allocating a priority to the HARQ retransmissions of the second packet beyond the preconfigured maximum number of HARQ retransmissions, the priority being the same priority as that assigned to at least one new packet directed to a second UE.

10. The apparatus of claim 8, further comprising means for adapting the transmission of the HARQ retransmissions in accordance with a channel quality indication received from the UE prior to the providing of the reconfiguration message.

11. The apparatus of claim 7, further comprising means for halting scheduling of packets to the UE after the providing of the reconfiguration message, until the indication is received from the UE that the change from the source cell to the target cell is complete.

12. The apparatus of claim 7, wherein the means for stalling the continued incrementing comprises means for halting transmission of packets to the UE until an indication is received that the change from the source cell to the target cell is complete.

13. A computer program product, comprising:
a computer-readable medium comprising code for:
allocating a first sequence number to a first packet to be sent to a UE;
transmitting the first packet on a first downlink channel from a source cell to the UE;
incrementing the sequence number to a sequential sequence number;
allocating the sequential sequence number to a second packet to be sent to the UE;
providing a reconfiguration message for a UE to change from the source cell to a target cell; and
stalling a continued incrementing of the sequence number until an indication is received from the UE that the change from the source cell to the target cell is complete.

14. The computer program product of claim 13, wherein the computer-readable medium further comprises code for transmitting HARQ retransmissions of the second packet beyond a preconfigured maximum number of HARQ retransmissions.

15. The computer program product of claim 14, wherein the computer-readable medium further comprises code for allocating a priority to the HARQ retransmissions of the second packet beyond the preconfigured maximum number of HARQ retransmissions, the priority being the same priority as that assigned to at least one new packet directed to a second UE.

16. The computer program product of claim 14, wherein the computer-readable medium further comprises code for adapting the transmission of the HARQ retransmissions in accordance with a channel quality indication received from the UE prior to the providing of the reconfiguration message.

17. The computer program product of claim 13, wherein the computer-readable medium further comprises code for halting scheduling of packets to the UE after the providing of the reconfiguration message, until the indication is received from the UE that the change from the source cell to the target cell is complete.

18. The computer program product of claim 13, wherein the code for stalling the continued incrementing comprises code for halting transmission of packets to the UE until an indication is received that the change from the source cell to the target cell is complete.

19. An apparatus for wireless communication, comprising:
at least one processor; and
a memory coupled to the at least one processor,
wherein the at least one processor is configured to:
allocate a first sequence number to a first packet to be sent to a UE;
transmit the first packet on a first downlink channel from a source cell to the UE;
increment the sequence number to a sequential sequence number;
allocate the sequential sequence number to a second packet to be sent to the UE;
provide a reconfiguration message for a UE to change from the source cell to a target cell; and
stall a continued incrementing of the sequence number until an indication is received from the UE that the change from the source cell to the target cell is complete.

20. The apparatus of claim 19, wherein the at least one processor is further configured to transmit HARQ retransmissions of the second packet beyond a preconfigured maximum number of HARQ retransmissions.

21. The apparatus of claim 20, wherein the at least one processor is further configured to allocate a priority to the HARQ retransmissions of the second packet beyond the preconfigured maximum number of HARQ retransmissions, the priority being the same priority as that assigned to at least one new packet directed to a second UE.

22. The apparatus of claim 20, wherein the at least one processor is further configured to adapt the transmission of the HARQ retransmissions in accordance with a channel quality indication received from the UE prior to the providing of the reconfiguration message.

23. The apparatus of claim 19, wherein the at least one processor is further configured to halt scheduling of packets to the UE after the providing of the reconfiguration message, until the indication is received from the UE that the change from the source cell to the target cell is complete.

24. The apparatus of claim 19, wherein the stalling of the continued incrementing comprises halting transmission of packets to the UE until an indication is received that the change from the source cell to the target cell is complete.
